(19) United States
(12) Patent Application Publication
(10) Pub. No.: US 2019/0340718 A1
(43) Pub. Date: Nov. 7, 2019

(54) Systems and Methods for Posting Bail By Surrendering Illegally Possessed Items

(71) Applicant: Trevor Aganda Brooks, Baltimore, MD (US)

(72) Inventor: Trevor Aganda Brooks, Baltimore, MD (US)

(73) Assignee: Gunbail, Inc., Florissant, MO (US)

(21) Appl. No.: 15/969,910

(22) Filed: May 3, 2018

(51) Int. Cl. G06Q 50/26; G06Q 10/08; G06Q 20/10

(52) U.S. Cl. CPC G06Q 50/26; G06Q 20/10; G06Q 10/0832

(57) ABSTRACT

Systems and methods for posting bail by surrendering illegal items such as firearms are described. In one embodiment, the system comprises a downloadable software application that allows a detention center to request the posting of bail for a qualified detainee using the present system, prompting a user having downloaded the application to respond to the request on behalf of the detainee. The system further allows for the user to return an illegally possessed firearm during a provided amnesty period and allows law enforcement to track its return to an authorized receiving party. Once the firearm is safely returned, the detainee is released. The present invention reduces the cost of detaining individuals eligible for bail while reducing the number of illegal firearms in circulation, thereby improving public safety.

### STATEMENT REGARDING FEDERALLY SPONSORED RESEARCH OR DEVELOPMENT

This invention was not made with federal government support.

### BACKGROUND OF THE INVENTION

During the last decade, the amount of violence in and around urban areas in particular has steadily increased, due in large part to an increased number of illegal firearms such as guns in these areas that contribute to such violence. Accordingly, systems and methods are needed to reduce the number of guns in attempt to diminish violence. The present invention provides such systems and methods.

Statistics show that approximately 11 million arrests are made by law enforcement annually in the United States. Of the arrested, approximately 75% cannot afford to post bail, and thus must remain incarcerated at great cost to state, local and federal governments, and ultimately taxpayers. Of these arrested, approximately 60% will ultimately be released, whether under work release programs, on conditions of probation, or because they are not found guilty of the offense of which they are charged. In addition, statistics suggest that approximately 55% of these arrested have access to firearms through friends, family or associates. It is estimated at the time of this filing that approximately 370 million illegally possessed guns remain in circulation with recovery by law enforcement being less than one percent. The present invention enables a detainee who cannot afford bail to contact a loved one, for example, who can access the software application of the present invention in order to secure the release of the detainee, subject to qualification by law enforcement (e.g., after a determination that the detainee is not subject of major outstanding warrants or otherwise presents a danger to others), and using the application, arrange for the controlled surrender of an illegally possessed illegal item such as a gun to the custody of law enforcement.

It is estimated that release of 7.5-9 million detainees under the systems and methods of the present invention is possible based on statistics. Currently, only about 25% of the 11 million people arrested annually are able to secure release though a bail bond, leaving several million of those arrested to remain incarcerated until appearing before a judge, for example, days, weeks or even months later at great taxpayer expense.

### BRIEF SUMMARY OF THE INVENTION

The present invention is that of a system and method for reducing the governmental burden of housing detainees in jails or prisons while at the same time reducing the number of illegal items, particularly firearms, on the streets of our nation, and in particular our urban communities. A software application is described herein, which can be downloaded by a user to a computing device (also referred to herein as a communication device), defined herein to include desktop or laptop computers, or portable electronic devices such as smartphones, to facilitate the posting of bail in the form of surrender of one or more firearms to the appropriate authorities.

The software application of the present invention is downloadable to computing devices, particularly to portable electronic devices, by users including law enforcement personnel and licensed gun dealers. The software application is accompanied by support from federal, state and local governments interested in reducing their prison populations. Detainees can secure bail in exchange for the surrender of firearms in their possession. Each firearm is provided with a unique tracking means, such as a barcode, QR code or equivalent, which is created to track the surrendered gun until it is in the custody of law enforcement. In one embodiment, a user having downloaded the application takes a digital photograph of the surrendered firearm, then the application tags the firearm with the tracking means. The user then can select the detention center where the detainee of interest is being detained, which maintains a database of all detainee information for that facility. Using the application of the present invention, the user can identify the detainee according to information within the database, and select that detainee for posting bail under the system and method described herein. The user then also enters his or her username and location, which is geotagged by the application, authorizes an electronic bail payment, and is provided with an amnesty period during which he or she must surrender the firearm to a local gun dealer or other authorized receiving party, or directly to law enforcement personnel, to secure the release of the detainee. In a preferred embodiment, the user-authorized bail payment is authorized, made or guaranteed with state, local or federal government funds.

In one embodiment, the amnesty period provides adequate time for the user to obtain a firearm lock, such as a trigger lock or equivalent and disable the firearm with the lock prior to journeying to the location of the receiving party to surrender the firearm. Upon receipt of the firearm, the receiving party, having downloaded the application to a smartphone, for example, scans the tracking means displayed on the user's device with the smartphone. Once the tracking means has been scanned by the receiving party, law enforcement is alerted that the firearm has been surrendered and can schedule pickup of the firearm, thereby completing the process of removing the firearm from circulation and consummating the detainees release. In one embodiment, law enforcement personnel having downloaded the application may receive the firearm directly and scan the tracking means to complete the process.

### BRIEF DESCRIPTION OF THE DRAWINGS

FIG. 1 illustrates an exemplary system 100 for receiving an illegal item in exchange for release of an individual from a detention center in accordance with embodiments of the present invention, including a device 105 to which the application of the present invention is downloaded from a network 101 in communication with one or more servers 102 housing the software module 103 and at least one database 104.

FIG. 2 illustrates an exemplary computing system 105 of the present invention, comprising databases 112 and 113 containing personal and illegal item information stored on a server 109, a software application 110 for download to a communication device 107 which enables role-based use of the system.

FIG. 3 illustrates a portable electronic device in communication with the servers of the present invention comprising database information, with fields shown where queries can be made by a user of the system as to personal information of a detainee 113.

FIG. 4 illustrates information displaying on a portable electronic device in response to a query such as the type indicated in FIG. 3, including detainee name 114 picture 115 and one or more criminal charges against the detainee 116.

FIG. 5 a prompt for the user entering information into the application to enter his or her personal and location information 117.

FIG. 6 illustrates a portable electronic device displaying a firearm surrendered under the system of the present invention 119 confirming surrender 120 with adequate time remaining on the amnesty clock 121 and the name of the detainee surrendering the firearm 122.

### DETAILED DESCRIPTION OF THE INVENTION

The systems and methods disclosed herein are directed to a software application useful in receiving and validating the receipt of one or more illegal items in exchange for release of an individual from a detention center. The illegal item can be any type of good unlawfully possessed, transported or produced, including but not limited to, drugs, firearms or bladed or pointed articles (e.g., knives or shanks). The detention center can be any place of holding that detains an individual for a wrongdoing in violation of the law including but not limited to a federal or state jail or prison, a juvenile detention center, or a military detention center. The detainment center can be a private or public facility.

Reference will now be made in detail to various embodiments of the present invention, examples of which are illustrated in the accompanying drawings. It is to be understood that the figures and descriptions of the present invention included herein illustrate and describe elements that are of relevance to the present invention.

In one embodiment, a user of the application able to return an illegal gun, for example, on behalf of a detainee, may take a digital photograph of the gun using a portable electronic device (preferably a smartphone), enter his or her geographic location (which is then geotagged by the application), enter his or her personal information, and begin the process of surrendering the firearm in exchange for release of the detainee. Law enforcement officials who have downloaded the application to a computing device may use it to track the progress of the surrendered item once it has been photographed and provided with a tracking means, such as a barcode, QR code or equivalent. A bail payment amount is then displayed on the smartphone face, which can be paid by any electronic means familiar to one of ordinary skill in the art, for example, by entering credit card information for processing. In a preferred embodiment, local, state or federal government has pre-authorized payment and the user need not pay using his or her own funds. Instructions are then provided on the smartphone for returning the firearm to, for example, law enforcement or licensed gun dealers, and an amnesty clock is provided, which reflects the amount of time during which the surrender the of the firearm must occur to secure the release of the detainee. In a preferred embodiment, additional time is allowed for the user to secure a locking means such as a trigger lock before transporting the firearm to the authorized receiving party.

The application displays the nearest locations to which the firearm can be returned with directions. The party receiving the firearm can download the application and create a login. Once logged in, the party receiving the firearm can scan the tracking means when displayed by the person delivering it, which alerts law enforcement personnel having downloaded the application that the firearm has been surrendered and can be taken into custody, thereby allowing for release of the detainee.

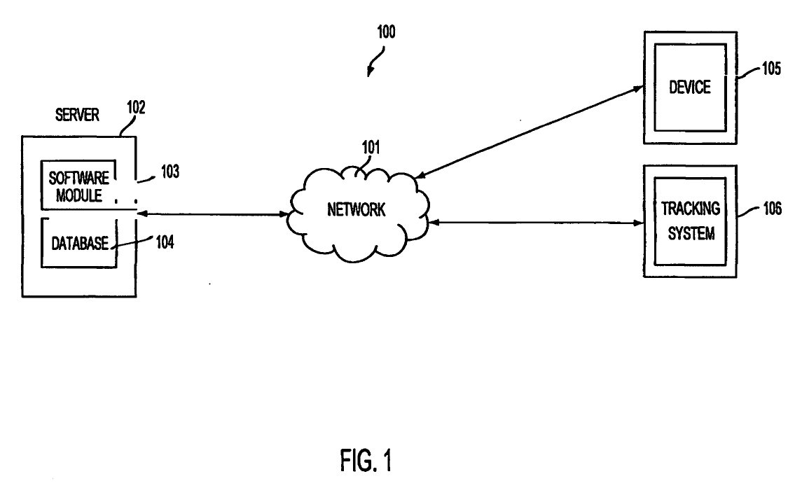

Referring now to FIG. 1, an exemplary system shown generally as reference 100 is provided for facilitating the receipt of one or more illegal items in exchange for release of a detainee from a detention center. As shown, the system 100 can include a network 101, a server 102, a computing device 105, and a tracking system 106. A network 101 can provide network access, data transport and other services to the devices coupled to it in order to send and receive data from any number of computing devices. In general, the network 101 can include and implement any commonly defined network architectures including those defined by standards bodies, such as the Global System for Mobile Communication (GSM) Association, the Internet Engineering Task Force (IETF), and the Worldwide Interoperability for Microwave Access (WiMAX) forum. For example, the network 101 can implement one or more of a GSM architecture, a General Packet Radio Service (GPRS) architecture, a Universal Mobile Telecommunications System (UMTS) architecture, and an evolution of UMTS referred to as Long Term Evolution (LTE). The network 101 can, again as an alternative or in conjunction with one or more of the above, implement a WiMAX architecture defined by the WiMAX forum.

The network 104 can also comprise, for instance, a local area network (LAN), a wide area network (WAN), the Internet, a virtual LAN (VLAN), an enterprise LAN, a virtual private network (VPN), an enterprise IP network, or any combination thereof.

A server 102 can also be any type of communication device coupled to the network 101, including but not limited to a personal computer, a server computer, a series of server computers, a mini computer, and a mainframe computer, or combinations thereof. The server 102 can be a web server (or a series of servers) running a network operating system, examples of which can include, but are not limited to, Microsoft Windows Server, Novell NetWare, or Linux. The server 102 can be in communication with a cloud or local public or private network.

The software module 103 can be a module that is configured to send, process, and receive information at the server 102. The software module 103 can provide another mechanism for sending and receiving data at the server 102 besides handling requests through web server functionalities. The software module 103 can send and receive information using any technique for sending and receiving information between processes or devices including but not limited to using a scripting language, a remote procedure call, an email, a tweet, an application programming interface, Simple Object Access Protocol (SOAP) methods, Common Object Request Broker Architecture (CORBA), HTTP (Hypertext Transfer Protocol), REST (Representational State Transfer), or any interface for software components to communicate with each other, using any other known technique for sending information from one device to another, or any combination thereof.

Although the software module 103 can be described in relation to server 102, software module 103 can reside on any other device. Further, the functionality of software module 103 can be duplicated on, distributed across or performed by one or more other devices, either in whole or in part.

A database 104 can be any type of database, including a database managed by a database management system (DBMS). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Oracle database, IBM DB2, Adaptive Server Enterprise, FileMaker, Microsoft Access, Microsoft SQL Server, MySQL, PostgreSQL, and a NoSQL implementation. A DBMS typically includes a modeling language, data structure, database query language, and transaction mechanism. The modeling language is used to define the schema of each database in the DBMS, according to the database model, which can include a hierarchical model, network model, relational model, object model, or some other applicable known or convenient organization.

Data structures can include fields, records, files, objects, and any other applicable known or convenient structures for storing data. A DBMS can also include metadata about the data that is stored. Furthermore, database 104 can be managed by a single authorized entity or multiple authorized entities. An authorized entity can be a governmental entity or non-governmental entity. As such, the database 104 can be managed by the detainment center, a governmental entity, a third party, or any combination thereof. Exemplary governmental entities include, but are not limited to, municipalities, police departments, city police departments, state police departments, federal police departments, state agencies and federal agencies.

The database 104 can store one or more charges relating to any individual detained by a detention center. The database 104 can store the type of charge (felony or misdemeanor) and the name of the charge in a particular jurisdiction. As such, in one embodiment, the database 104 can store one or more charges of the detained individual in the particular jurisdiction. In another embodiment, the database can store and categorize charges of the detained individual across multiple jurisdictions. Exemplary jurisdictions include, but are not limited to, those of one or more cities, one or more states, or one or more nations or other sovereigns.

Along these lines, database 104 can store whether the detained individual is eligible for bail. Eligibility for bail can be based on the type or nature of the charge against the detained individual. In one embodiment, the detained individual may not be eligible for bail if the charge is a felony. In another embodiment, the detained individual may not be eligible for bail if the charge is violent in nature.

In addition, the database 104 can store processing information related to the detained individual. Exemplary processing information includes, but is not limited to, age, hair color, eye color, height, weight, birthdate, and detainee identification number.

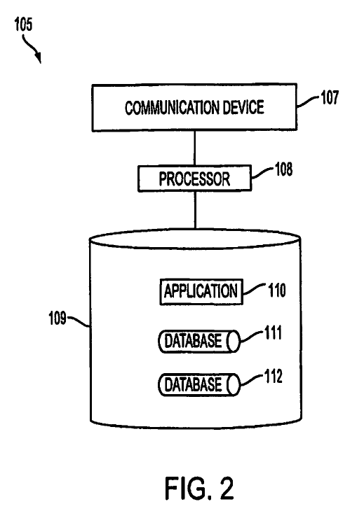

Referring now to FIG. 2, a schematic diagram of an exemplary computing device 105 that may be utilized in accordance with the present invention is illustrated. The exemplary computing device 105 can be any type of computing device coupled to the network 101 including, but not limited to, personal computers, mobile computers, laptops, netbooks, tablets and smartphones.

Furthermore, the computing device 105 can include a processor 108, a communication device 107 and a data storage or memory component 109. The processor 108 is in communication with both the communication device 107 and the memory component 109. The communication device 107 may be configured to communicate information via a communication channel, wired or wireless, to electronically transmit and receive digital data related to the functions discussed herein. The communication device 107 may also be used to communicate, for example, with one or more human readable display devices, such as an LCD panel, an LED display or other display device.

The communication device 107 may include an input device including any mechanism or combination of mechanisms that permit an operator to input information to the communication device 107, such as a camera, a keyboard, a mouse, a touch sensitive display device, a microphone, a stylus, a biometric input device, or a voice recognition device. The communication device 107 may include an output device that can include any mechanism or combination of mechanisms that outputs information to the operator, such as a display, a printer, or speaker.

The memory component 109 may comprise any appropriate information memory component, including combinations of magnetic memory components (e.g., magnetic tape, radio frequency tags, and hard disk drives), optical memory components, computer readable media, or semiconductor memory devices such as Random-Access Memory (RAM) devices and Read-Only Memory (ROM) devices. The memory component 109 may store an application 110 for controlling the processor 108. The processor 108 performs instructions of the application 110, and thereby operates in accordance with the present invention. The memory component 109 may also store and send all or some of the information sent to the processor 108 in one or more databases 111 and 112.

An application 110 can allow the user to submit an illegal item in exchange for bail of a detained individual. The illegal item can belong to the detained individual, the user, or any other individual. To submit the illegal item, the application 110 can require several parameters for eligibility of the illegal item including, but not limited to, operability, type, and age of the illegal item. For example, in one embodiment, the application 110 can require a firearm to be operational in order to be used as bail.

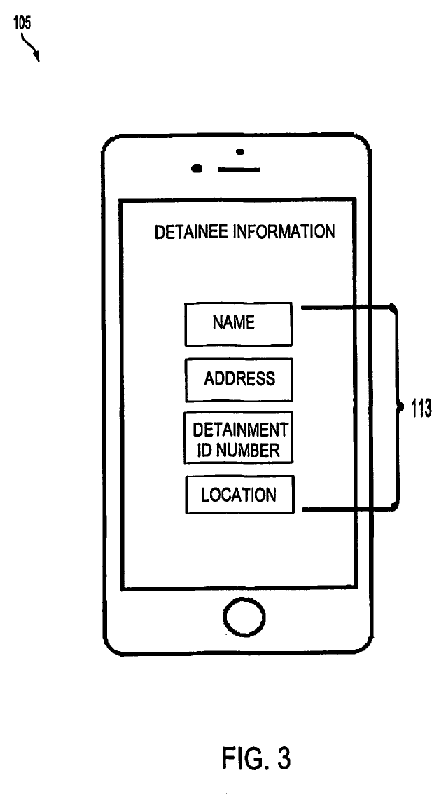

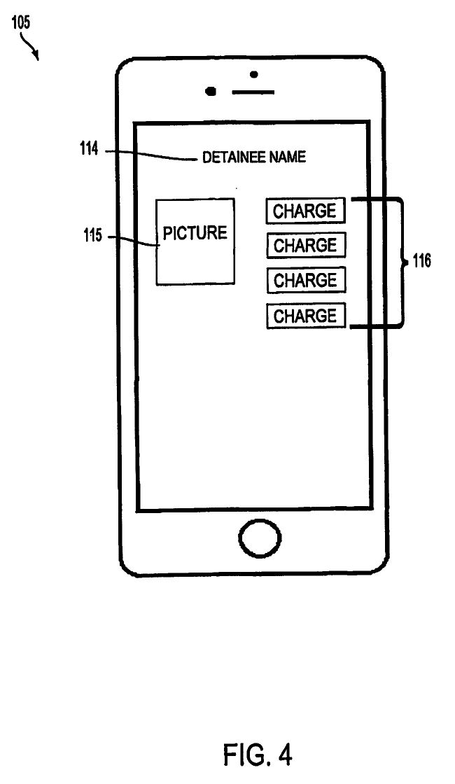

To locate the detained individual, the application 110 can present several search queries relating to the detained individual. The search queries can relate to any information stored in the database 104 of the server 101 (illustrated in FIG. 1) as discussed above. For example, as shown in FIG. 3, the search queries 113 presented by the computing device 105 can be a name of the detained individual, an address of the detained individual, an identification number of the detained individual, a location of the detention center holding the detained individual, or combinations thereof. Thereafter, the computing device 105 can retrieve and present information applicable to the detained individual from the database 104 of the server 101 (illustrated in FIG. 1). Upon retrieval, the computing device 105 can display the applicable information to the user. The applicable information can relate to any information stored in the database of the server 101 (illustrated in FIG. 1) as described above. For example, as shown in FIG. 4, the computing device 105 can retrieve and present a name of the detainee 114, a picture of the detainee 115, and one or more charges 116 related to the detainee. The application 110 can then determine if the detained individual is eligible for bail based on the one or more charges as discussed above. If the detained individual is eligible for bail, the application 110 can allow the user to exchange the illegal item for release of the detained individual.

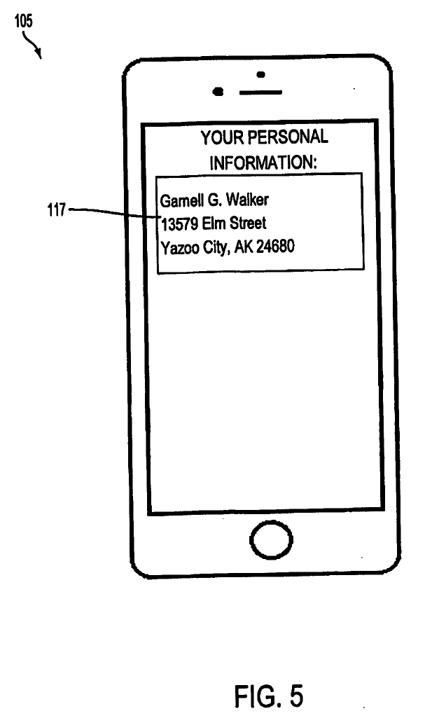

The application 110 can also prompt the user to enter personal information. Personal information can be entered via an input device of the communication device 107, and it can contain any information identifying the user. For example, as illustrated in FIG. 5, the personal information of the user can include their name and address.

The application 110 can further permit the user to enter identifying information of the illegal item. The identifying information can be entered through the input device of the communication device 107. As stated above, the input device can be a camera or a touch screen of a mobile phone. As such, in one embodiment, the user can enter identifying information of the illegal item by taking one or more pictures of the illegal item. In another embodiment, the user can enter identifying information of the illegal item by entering a serial number of the illegal item.

The application 110 can additionally require payment of a fee for shipping a box for securing the illegal item from the user. According to an embodiment, the shipping box can be a pre-paid shipping box. The box can allow the user to safely pack the illegal item during transportation to a designated secure location. The box can include any mechanisms to protect the illegal item during transportation, such as a lock for a firearm (e.g., a trigger lock). Moreover, the designated location can be any secured location including, but not limited to, the detention center, a local police station, a private third-party location, or other authorized locations.

Upon identification of the detained individual, entry of the user's personal information, and entry of the identifying information of the illegal item, the user can be provided an allotted period of time for a designated secure location to receive the illegal item. The allocated period of time can be any period of time sufficient to allow the user to transfer the illegal item to the secure location. For example, the allotted period of time can be two hours.

Moreover, the user can transfer the illegal item illegal item to the secure location by any number of prescribed manners. For example, in one embodiment, the user can physically transport the illegal item to the secure location. Alternatively, in another embodiment, the user can ship a package containing the illegal item to the secure location via a courier service, such as Fed Ex®, USPS® or UPS®.

During the allotted period of time, a user or detainee can be provided immunity from any crimes related to the illegal item included, but not limited to, possession of the illegal item, transportation of the illegal item, past or future crimes involving the illegal item, etc. This can motivate a user to turn over the illegal item in exchange for bail of the detained individual. However, in some embodiments, when the detained individual is on bail and does not appear in court, the user can be liable for some or any crimes related to the illegal item. This can motivate a user to ensure that the detained individual returns to a court date upon bail.

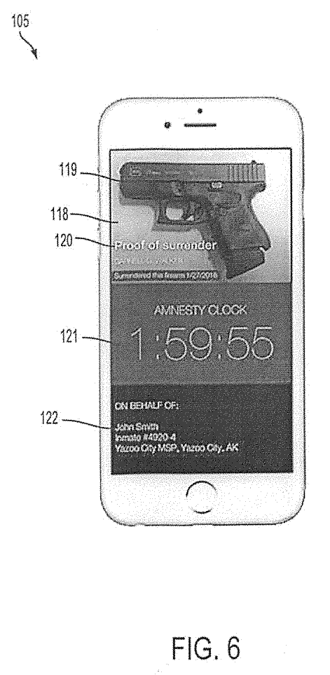

Referring now to FIG. 6, while the user is provided the allotted period of time to transport the illegal item to the secure location, the computing device 105 may simultaneously present three windows 118, 119 and 120 to the user. A window 118 can provide a proof of surrender of the illegal item that includes any information relating to the illegal item, such as but not limited to a picture of the illegal item 119, the name of the user, and the date the illegal item was surrendered 120. A second window 121 can provide the remaining allotted time for amnesty of crimes relating to the illegal item. Window 122 can provide identifying information of the detained individual including, but not limited to, the name of the detained individual, a detainee number of the detained individual, and an address of the detainment center where the individual is being detained.

Referring to FIG. 1, a tracking system 106 can be any type of communication device that is coupled to network 101 and configured to track the illegal item, including but not limited to Radio Frequency Identification (RFID) systems, Global Positioning Systems (GPS), Geofencing systems, etc. The tracking system 106 can include a tracking number provided on the box containing the illegal item. The tracking number provided on the box can be any unique number assigned by a courier service, such as Fed Ex®, USPS® or UPS®.

To track the illegal item, the tracking system 106 can be physically coupled to one or both of the illegal item or the box containing the illegal item. The tracking system 106 can track the illegal item or the box containing the illegal item for a prescribed period of time. For example, the tracking system 106 can track the illegal item or the box containing the illegal item until receipt at the secure location. As such, the tracking system 106 can track the illegal item or box containing the illegal item past the allowed period of time.

Upon receipt of the illegal item by the secure location, processing relating to the illegal item or the detained individual can be required prior to the detained individual being released from the detainment center. Processing of the illegal item can include matching the surrendered illegal item to the identifying information entered into the system. Processing of the detained individual can include transferring funds to an authorized party who will pay an authority reliable for the bail of the detained individual. Alternatively, processing of the detained individual can include sending instructions to the detainment center that the detained individual should be released on bail.

In an exemplary method for receiving an illegal item in exchange for release of an individual from a detention center, a database of one or more charges of an individual is created on a server. Thereafter, a request for bail of the individual from the detention center is received from a computing device. Subsequently, identification information relating to the illegal item is received from the computing device. Lastly, the illegal item is tracked by a tracking device until received at a secure location. Upon receipt of the illegal item at the secure location, the detained individual is eligible for bail, and the system instructs the detainment center that the detained individual should be released on bail. Subsequently, the detained individual is released from the detention center. Each of the aforementioned steps can be performed in accordance with embodiments of the invention as described above.

Although the foregoing description is directed to the preferred embodiments of the invention, it is noted that other variations and modifications will be apparent to those skilled in the art, and can be made within the scope of the present invention. Moreover, features described in connection with one embodiment of the invention can be used in conjunction with other embodiments, even if not explicitly stated above.

What is claimed is:

1. A system for receiving an illegal item in exchange for release of at least one individual from a detention center, the system comprising:
at least one server or equivalent comprising:
at least one database storing a name of the at least one individual and one or more criminal charges of the at least one individual;
at least one computing device in communication with the at least one server or equivalent, wherein the computing device comprises an application configured to receive information relating to the illegal item and a request for release of the at least one individual from the detention center; and
a tracking system in communication with the at least one server or equivalent and the at least one computing device, wherein the tracking system is configured to track the illegal item until receipt of the illegal item at a designated location;
wherein the at least one individual is eligible for bail from the detention center upon receipt of the illegal item at the designated location.

2. The system of claim 1, wherein the illegal item is a firearm or a drug.

3. The system of claim 1, wherein the at least one server or equivalent is maintained by the detention center.

4. The system of claim 1, wherein the at least one server comprises the tracking system.

5. The system of claim 1, wherein the at least one computing device is a mobile device comprising a camera capable of taking a picture of the illegal item.

6. The system of claim 1, wherein the information comprises a serial number of the illegal item.

7. The system of claim 1, wherein the designated location is a governmental entity.

8. The system of claim 1, wherein the designated location is a non-governmental entity.

9. A method for receiving an illegal item in exchange for release of at least one individual from a detention center, the method comprising the steps of:
receiving, by a computing device, a request for bail of the individual from the detention center;
receiving, by the computing device, identifying information relating to the illegal item; and
tracking, by a tracking device, the illegal item until receipt at a designated location, wherein the at least one individual is eligible for bail from the detention center upon receipt of the illegal item at the designated location.

10. The method of claim 9, further comprising storing, on a server or equivalent, a database comprising one or more criminal charges of the at least one individual.

11. The method of claim 9, further comprising:
receiving, by the computing device, a payment for sending a box for shipment of the illegal item to the designated location.

12. The method of claim 10, further comprising sending a box for shipment of the illegal item to the designated location.

13. The method of claim 12, wherein the illegal item is a firearm and the box contains a lock for the firearm.

14. The method of claim 10, further comprising: providing, by the computing device, an allotted period of time for the designated location to receive the illegal item.

15. The method of claim 14, wherein the allotted period of time provides one or both of a user of the method or the at least one individual with immunity from one or more criminal charges of the at least one individual involving said illegal item.

16. The method of claim 9, wherein the at least one individual is released from the detention center upon receipt of the illegal item at the designated location.

17. A non-transitory computer-readable medium tangibly storing computer program instructions which when executed by a processor cause the processor to:
receive a request for bail of at least one individual from the detention center;
receive identifying information relating to the illegal item; and
track the illegal item until receipt at a designated location, wherein the at least one individual is eligible for bail from the detention center upon receipt of the illegal item at the designated location.

18. The non-transitory computer readable medium of claim 17, wherein the computer program instructions additionally cause the processor to receive a payment for sending a box for shipment of the illegal item to the designated location.

19. The non-transitory computer-readable medium of claim 17, wherein the computer program instructions additionally cause the processor to provide an allotted period of time for the designated location to receive said illegal item, wherein the allotted period of time provides immunity for one or more charges related to said illegal item.
